(19) United States
(12) Patent Application Publication
(10) Pub. No.: US 2024/0312657 A1
(43) Pub. Date: Sep. 19, 2024

(54) CONTROLLING A MAGNETIC FIELD OF A MAGNETIC CONFINEMENT DEVICE USING A NEURAL NETWORK

(71) Applicant: DeepMind Technologies Limited, London (GB)

(72) Inventors: Jonas Degrave, London (GB); Federico Alberto Alfredo Felici, Lausanne (CH); Jonas Buchli, London (GB); Michael Peter Neunert, London (GB); Brendan Daniel Tracey, London (GB); Francesco Carpanese, Lausanne (CH); Timo Victor Ewalds, London (GB); Roland Hafner, Balgheim (DE); Martin Riedmiller, Balgheim (DE)

(21) Appl. No.: 18/572,914

(22) PCT Filed: Jul. 8, 2022
(86) PCT No.: PCT/EP2022/069047

§ 371 Date: Dec. 21, 2023

Related U.S. Application Data
(60) Provisional application No. 63/219,601, filed on Jul. 8, 2021.

(51) Int. Cl. G21D 3/00; G21B 1/05

(52) U.S. Cl. CPC G21D 3/001; G21B 1/05

(57) ABSTRACT

Methods, systems, and apparatus, including computer programs encoded on a computer storage medium, for generating control signals for controlling a magnetic field for confining plasma in a chamber of a magnetic confinement device. One of the methods includes, for each of a plurality of time steps, obtaining an observation characterizing a current state of the plasma in the chamber of the magnetic confinement device, processing an input including the observation using a plasma confinement neural network to generate a magnetic control output that characterizes control signals for controlling the magnetic field of the magnetic confinement device, and generating the control signals for controlling the magnetic field of the magnetic confinement device based on the magnetic control output.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a nonlinear transformation to a received input to generate an output.

### SUMMARY

This specification generally describes a system implemented as computer programs on one or more computers in one or more locations that uses a plasma confinement neural network to generate control signals for controlling a magnetic field for confining plasma in a chamber of a magnetic confinement device. The magnetic confinement device can be, e.g., a tokamak having a toroidal shaped chamber.

In one aspect there is described a method performed by one or more data processing apparatus for generating control signals for controlling a magnetic field for confining plasma in a chamber of a magnetic confinement device. The method involves, at each of a plurality of time steps, obtaining an observation characterizing a current state of the plasma in the chamber of the magnetic confinement device and processing an input including the observation characterizing the current state of the plasma in the chamber of the magnetic confinement device using a plasma confinement neural network. The plasma confinement neural network has a plurality of network parameters and is configured to process the input including the observation in accordance with the network parameters to generate a magnetic control output that characterizes control signals for controlling the magnetic field of the magnetic confinement device. The method further involves generating the control signals for controlling the magnetic field of the magnetic confinement device based on the magnetic control output.

In some implementations, the magnetic control output characterizes a respective voltage to be applied to each of a plurality of control coils of the magnetic confinement device.

In some implementations, the magnetic control output defines, for each of the plurality of control coils of the magnetic confinement device, a respective score distribution over a set of possible voltages that can be applied to the control coil.

In some implementations, generating control signals for controlling the magnetic field of the magnetic confinement device based on the magnetic control output involves, for each of the plurality of control coils of the magnetic confinement device: selecting a voltage from the respective score distribution over the set of possible voltages that can be applied to the control coil and generating a control signal to cause the sampled voltage to be applied to the control coil.

The method may also involve determining, for each of the plurality of time steps, a reward for the time step that characterizes an error between: (i) the current state of the plasma, and (ii) a target state of the plasma and training the neural network parameters of the plasma confinement neural network on the rewards using a reinforcement learning technique.

In some implementations, for one or more of the plurality of time steps, determining the reward for the time step includes: determining, for each of one or more plasma features characterizing the plasma, a respective error that measures a difference between: (i) a current value of the plasma feature at the time step, and (ii) a target value of the plasma feature at the time step. The method further involves determining the reward for the time step based at least in part on the respective error corresponding to each of the one or more plasma features at the time step.

The method may also involve, for one or more of the plurality of time steps, determining the reward for the time step based on the respective error corresponding to each of the plasma features at the time step includes: determining the reward for the time step as a weighted linear combination of the respective errors corresponding to the plasma features at the time step.

In some implementations, the respective target values of each of one or more of the plasma features vary between time steps.

In some implementations, at each of the plurality of time steps, the input to the plasma confinement neural network includes data defining the respective target value of each of the plasma features at the time step in addition to the observation for the time step.

In some implementations, the plasma features include one or more of: a stability of the plasma, a plasma current of the plasma, a shape of the plasma, a position of the plasma, an area of the plasma, a number of domains of the plasma, a distance between droplets of plasma, an elongation of the plasma, a radial position of a plasma center, a radius of the plasma, a triangularity of the plasma, or a limit point of the plasma.

In some implementations, for one or more of the plurality of time steps, determining the reward for the time step includes: determining a respective current value of each of one or more device features characterizing a current state of the magnetic confinement device and determining the reward for the time step based at least in part on the respective current values of the one or more device features at the time step.

In some implementations, the device features include: a number of x-points in the chamber of the magnetic confinement device, a respective current in each of one or more control coils of the magnetic confinement device, or both.

In some implementations, the magnetic confinement device is a simulation of a magnetic confinement device. The method may further involve, at a final time step of the plurality of time steps: determining that a physical feasibility constraint of the magnetic confinement device is violated at the time step and terminating the simulation of the magnetic confinement device in response to determining that the physical feasibility constraint of the magnetic confinement device is violated at the time step.

In some implementations, determining that the physical feasibility constraint of the magnetic confinement device is violated at the time step involves one or more of: determining that a density of the plasma at the time step does not satisfy a threshold, determining that a plasma current of the plasma at the time step does not satisfy a threshold, or determining that a respective current in each of one or more of the control coils does not satisfy a threshold.

In some implementations, the reinforcement learning technique is an actor-critic reinforcement learning technique. In further implementations, training the network parameters of the plasma confinement neural network on the rewards includes: jointly training the plasma confinement neural network and a critic neural network on the rewards using the actor-critic reinforcement learning technique. The critic neural network is configured to process an input including a critic observation for a time step to generate an output that characterizes a cumulative measure of rewards that are predicted to be received after the time step.

In some implementations, the actor-critic reinforcement learning technique is a maximum a posteriori policy optimization (MPO) technique.

In some implementations, the actor-critic reinforcement learning technique is a distributed actor-critic reinforcement learning technique.

In some implementations, the plasma confinement neural network generates outputs using fewer computational resources than are required by the critic neural network to generate outputs.

In some implementations, the plasma confinement neural network generates outputs with lower latency than is required by the critic neural network to generate outputs.

In some implementations, the plasma confinement neural network has fewer network parameters than the critic neural network.

In some implementations, the plasma confinement neural network is a feed-forward neural network and the critic neural network is a recurrent neural network.

In some implementations, the critic neural network is configured to process critic observations having a higher dimensionality and including more data than observations processed by the plasma confinement neural network.

In some implementations, at each of the plurality of time steps, the observation characterizing the current state of the plasma in the chamber of the magnetic confinement devices includes one or more of: a respective magnetic flux measurement obtained from each of one or more wire loops, a respective magnetic field measurement obtained from each of one or more magnetic field probes, or a respective current measurement from each of one or more control coils of the magnetic confinement device.

In some implementations, the magnetic confinement device is a simulated magnetic confinement device.

The method may also involve, after training the plasma confinement neural network based on controlling the simulated magnetic confinement device using the plasma confinement neural network: using the plasma confinement neural network to control a magnetic field for confining plasma in a chamber of a real-world magnetic confinement device by processing observations generated from one or more sensors of the real-world magnetic confinement device and using magnetic control outputs generated by the plasma confinement neural network to generate real-world control signals for controlling the magnetic field of the real-world magnetic confinement device.

In some implementations, the magnetic confinement device is a tokamak and the chamber of the magnetic confinement device has a toroidal shape.

In some implementations, the plasma is used to generate electrical power through nuclear fusion.

In a second aspect, there is provided one or more non-transitory computer storage media storing instructions that when executed by one or more computers cause the one or more computers to perform operations of the previously described method.

In a third aspect, there is provided a system including one or more computers and one or more storage devices communicatively coupled to the one or more computers, where the one or more storage devices store instructions that, when executed by the one or more computers, cause the one or more computers to perform operations of the previously described method.

In a fourth aspect, there is provided a method performed by one or more data processing apparatus for generating control signals for controlling a magnetic field for confining plasma in a chamber of a magnetic confinement device. The method includes, at each of a plurality of time steps: obtaining an observation characterizing a current state of the plasma in the chamber of the magnetic confinement device and processing an input including the observation characterizing the current state of the plasma in the chamber of the magnetic confinement device using a trained plasma confinement neural network. The trained plasma confinement neural network has a plurality of network parameters and is configured to process the input including the observation in accordance with the network parameters to generate a magnetic control output that characterizes control signals for controlling the magnetic field of the magnetic confinement device. The method further involves generating the control signals for controlling the magnetic field of the magnetic confinement device based on the magnetic control output.

The trained plasma confinement neural network may be used to control a real-world magnetic confinement device. More specifically, the trained plasma confinement neural network may be used to control a magnetic field for confining plasma in a chamber of a real-world magnetic confinement device by processing observations generated from one or more sensors of the real-world magnetic confinement device and using magnetic control outputs generated by the plasma confinement neural network to generate real-world control signals for controlling the magnetic field of the real-world magnetic confinement device. In some implementations the magnetic control output defines, for each control coil, a respective score distribution over a set of possible voltages that can be applied to the control coil. A voltage to be applied to the control coil may then be sampled from the score distribution.

In some implementations, the plasma confinement neural network is at least partly trained using a simulated magnetic confinement device, i.e. using a simulation of the real-world magnetic confinement device.

The subject matter described in this specification can be implemented in particular embodiments so as to realize one or more of the following advantages.

Magnetic confinement devices such as tokamaks are leading candidates for the generation of sustainable electric power through nuclear fusion. Efficient power production requires precise manipulation of magnetic fields of the magnetic confinement device to control the shape of the plasma in the chamber of the magnetic confinement device. Controlling the shape of the plasma can be a challenging problem, e.g., due to the potential instability of the plasma.

The system described in this specification uses a plasma confinement neural network to implement a control policy for selecting control signals for controlling the magnetic field of a magnetic confinement device. The plasma confinement neural network can be trained using reinforcement learning techniques to learn effective control policies, e.g., based on simulated trajectories characterizing the behavior of a simulated magnetic confinement device under the control of the plasma confinement neural network. The system can train the plasma confinement neural network based on rewards specified by control objectives, e.g., characterizing desired features of the plasma (e.g., the shape of the plasma) and/or operational constraints on the magnetic confinement device (e.g., the maximum allowable currents in the control coils). By training the plasma confinement neural network based on these rewards, the system enables the plasma confinement neural network to autonomously discover novel solutions for achieving the control objectives.

The system described in this specification represents a significant departure from existing controller design, where an exact target plasma state is specified and a combination of controllers are designed and tuned by sequential loop closing to first stabilize the plasma and then track the desired plasma state. In contrast to existing controllers designs, which require significant development time and manual fine-tuning, the system can autonomously train the plasma confinement neural network through reinforcement learning to learn effective control strategies. The system described in this specification can achieve performance comparable to or superior than existing controllers, while enabling more efficient use of resources (e.g., computational resources) once the neural network is trained. The system can significantly shorten and simplify the process of generating new magnetic field control policies (i.e., by autonomously learning control policies using reinforcement learning).

The system described in this specification can jointly train the plasma confinement neural network along with a critic neural network using actor-critic reinforcement learning techniques. The architectural complexity of the plasma confinement neural network is constrained by operational requirements, e.g., to generate magnetic control outputs with low latency (e.g., at a rate of 10 kHz or higher). In contrast, the critic neural network is only used during training, and is therefore not bound to satisfy the same operational constraints. Therefore, the system can implement the critic neural network with a significantly more complex neural network architecture that can enable the critic neural network to learn the dynamics of the magnetic confinement device more accurately and thus allow the plasma confinement neural network to not only be trained, but trained over fewer training iterations with improved performance.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example magnetic field control system.

FIG. 2 is a flow diagram of an example process for generating control signals using a plasma confinement neural network and training network parameters on rewards.

FIG. 3 illustrates an example process for determining a reward that can be used to train network parameters of a plasma confinement neural network.

FIG. 4 is an example of a simulation of a magnetic field confinement device that can be used during training of a plasma confinement neural network.

FIG. 5 is an example training engine using an actor-critic reinforcement learning technique.

FIG. 6 is a depiction of Tokamak a Configuration Variable (TCV).

FIGS. 7A and 7B are experimental data showing control of multiple plasma features using a magnetic field control system deployed on TCV.

Like reference numbers and designations in the various drawings indicate like elements.

### DETAILED DESCRIPTION

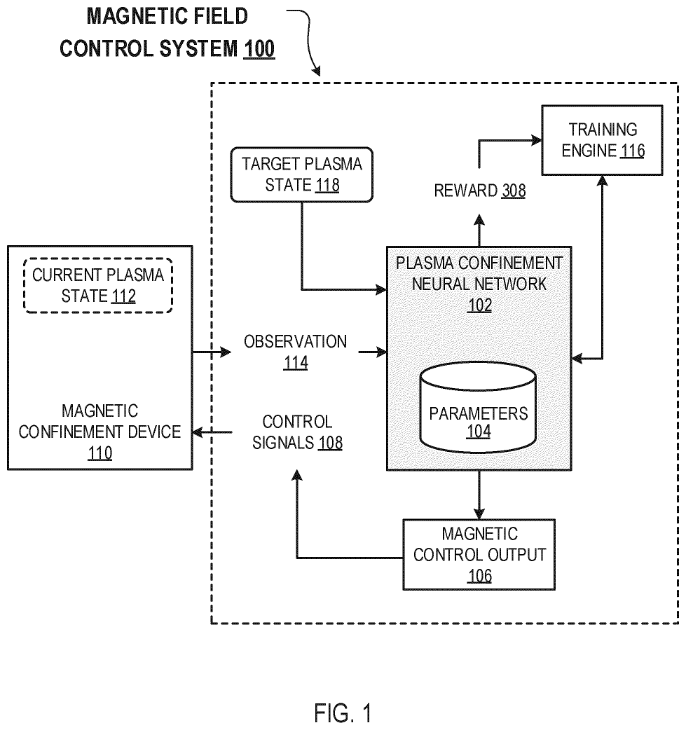

FIG. 1 shows an example magnetic field control system 100 that can control a magnetic field of a magnetic confinement device 110 using a plasma confinement neural network 102. The magnetic field control system 100 is an example of a system implemented as computer programs on one or more computers in one or more locations in which the systems, components, and techniques described below are implemented.

Controlled nuclear fusion, the fundamental process behind fusion reactors, is a promising solution for sustainable energy. Fusion reactors can use heat generated from fusion reactions occurring in a hot plasma to produce electrical power with very little radioactive waste. Aneutronic fusion reactors have potential for even greater efficiency as they can produce electrical power directly from charged particles emitted from the plasma. That being said, one of the most challenging problems in achieving controlled nuclear fusion is confining the high-temperature, high-pressure plasma within a suitable chamber. Due to the extreme temperatures (e.g., tens to hundreds of millions degrees Celsius), the plasma cannot be in direct contact with any surface of the chamber and must be suspended in a vacuum within it, which is further complicated by inherent instabilities of the plasma.

However, since a plasma is an ionized gas that conducts electricity, it produces strong magnetic fields, and in turn, can be manipulated by strong magnetic fields. Magnetic confinement devices 110, such as tokamaks, utilize a time-varying arrangement of magnetic fields to shape and confine plasmas into various plasma configurations. In tokamaks, like Tokamak à Configuration Variable (TCV) and ITER, the plasma is typically confined into a toroidal configuration (e.g., donut-like shape) that conforms to the toroidal shape of the chamber. A few other leading candidates for fusion reactor confinement devices 110 are spherical tokamaks (e.g., Mega Ampere Spherical Tokamak (MAST)), Stellarators (e.g., Wendelstein 7-X), field-reversed configurations (e.g., Princeton Field-Reversed Configuration (PFRC)), spheromaks, among others.

In general, the chamber geometry of a magnetic confinement device 110 constrains the possible plasma configurations. The ultimate goal of the control system 100 is to regulate magnetic fields within the confinement device 110 to establish a stable plasma configuration with a desired plasma current, position and shape, i.e., to establish plasma equilibrium. At equilibrium, sustained nuclear fusion can proceed. Several aspects of the plasma and the confinement device 110 itself can also be studied at equilibrium, e.g., the plasma's stability and energy exhaust, degradation of the confinement device's sensors, etc., which can be vital information for research and development.

Conventional magnetic controllers have commonly attacked the high-dimensional, high-frequency, nonlinear problem of plasma confinement using a set of independent single-input single-output proportional-integral-derivative (PID) controllers that adjust various features of the plasma. The set of PID controllers must be designed to avoid mutual interference and are often further augmented by an outer control loop that implements real-time estimation of the plasma equilibrium. Other types of linear controllers, as well as nonlinear controllers, have also be employed. Although these magnetic controllers have been successful in certain situations, they require considerable engineering effort and expertise whenever the target plasma configuration is changed. Moreover, the magnetic controllers must be designed for each confinement device 110 and their unique set of controls (e.g., set of control coils) which can be a painstaking task as successive generations of confinement devices 110 come online.

Conversely, since the control system 100 utilizes a neural network architecture, it can be configured as a nonlinear feedback controller for any confinement device 110. That is, the plasma confinement neural network 102 can autonomously learn a near-optimal control policy to efficiently command the set of controls, yielding a notable reduction in design effort compared with conventional magnetic controllers. A single computationally inexpensive control system 100 can replace a magnetic controller's complex nested control architecture. This approach can have unprecedented flexibility and generality due to specifying control objectives at a high level, which shifts the focus towards what the confinement device 110 should accomplish, rather than how it can be accomplished. An overview of the magnetic field control system 100 is outlined below.

Referring to the elements of FIG. 1, the plasma confinement neural network 102 includes a set of network parameters 104 that dictate how the neural network 102 processes data. Plasma confinement is a sophisticated temporal procedure as it can involve multiple transient periods, such as an initial plasma-formation phase, followed by stabilization to a plasma equilibrium and a final plasma-breakdown phase. Due to inherent instabilities of the plasma, the neural network 102 may also need to respond on short timescales to correct these instabilities. Although the control system 100 can be utilized for all stages involved in plasma confinement, in some implementations, the control system 100 is constrained to a specific stage. For example, a traditional magnetic controller can handle the initial plasma-formation phase and control can be switched at a predetermined time (“handover”) to the control system 100.

Accordingly, the plasma confinement neural network 102 can be configured to repeatedly process data at each of multiple time steps, where the time step usually corresponds to a particular control rate of the confinement device 110. The control rate is essentially the operational speed (e.g., latency) of the confinement device 110. In general, the neural network 102 can be configured for any desired control rate, even variable and non-uniform control rates. As will be described in more detail, the control system 100 can exploit certain neural network architectures for high-speed performance, making it aptly suited for deployment as a real-time-controller.

At each time step the control system 100 performs a control loop. The neural network 102 receives an observation 114 that characterizes a current state of the plasma 112 in the chamber of the magnetic confinement device 110. A reward 308 can be determined for the time step based on the current plasma state 112. Generally, the control system 100 determines the reward 308 by evaluating the current plasma state 112 against a target state of the plasma 118, which can vary between time steps. In this case, the target plasma state 118 can also act as a set point for the control system 100 at the particular time step.

The observation 114 is then processed by the neural network 102 in accordance with the network parameters 104 to generate a magnetic control output 106. The magnetic control output 106 characterizes control signals 108 for regulating the magnetic field of the magnetic confinement device 110. As a result, the magnetic field can be controlled by the control signals 108 in response to the observation 114 at the time step, which directly influences the evolution of the current plasma state 112. The control system 100 then repeats the control loop for the next time step. The rewards for the time steps can be utilized by a training engine 116 to train the network parameters 104 of the neural network 102, for example, using a reinforcement learning technique.

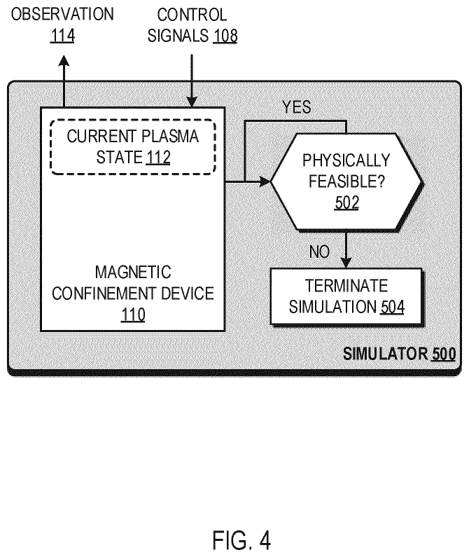

In some implementations, the control system 100 generates control signals 108 for a simulated magnetic confinement device 110 (depicted in FIG. 4). That is, the control system 100 trains the plasma confinement neural network 102 based on simulated trajectories characterizing the behavior of the simulated confinement device 110. After the plasma confinement neural network 102 is trained based on the simulated trajectories, the control system 100 can be deployed to control a real-world magnetic confinement device 110 (e.g., compiled into an executable). In particular, the control system 100 can be run “zero-shot” on real-world hardware, such that no tuning of the neural network 102 is required after training.

Optionally, the control system 100 can perform further training of the plasma confinement neural network 102 based on real-world trajectories characterizing the behavior of the real-world magnetic confinement device 110. Training the neural network 102 based on simulated trajectories generated by controlling a simulated confinement device 110 (i.e., instead of a real-world confinement device) can conserve resources (e.g., energy resources) required to operate the real-world confinement device 110. Training the neural network 102 based on simulated trajectories can also reduce the likelihood of the real-world confinement device 110 being damaged as a result of inappropriate control signals 108. The detailed processes of generating the control signals 108 and the rewards 308 necessary for training are described below.

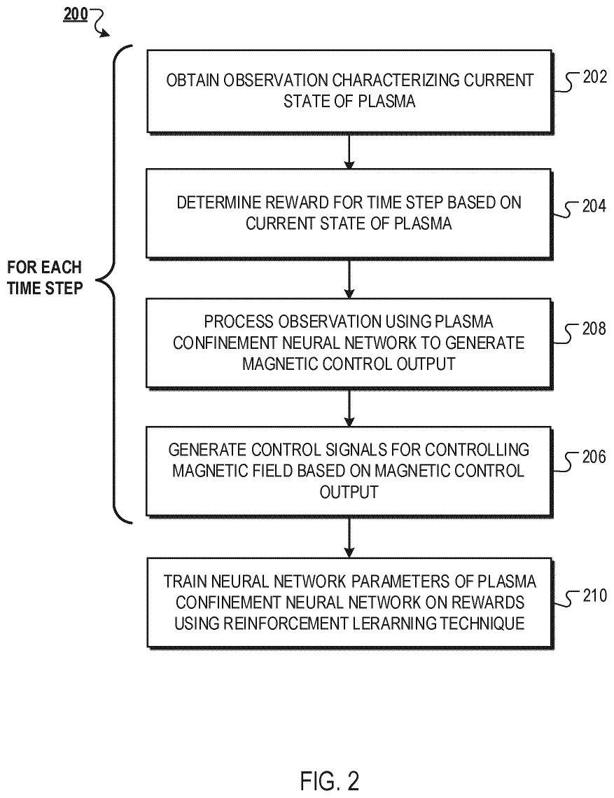

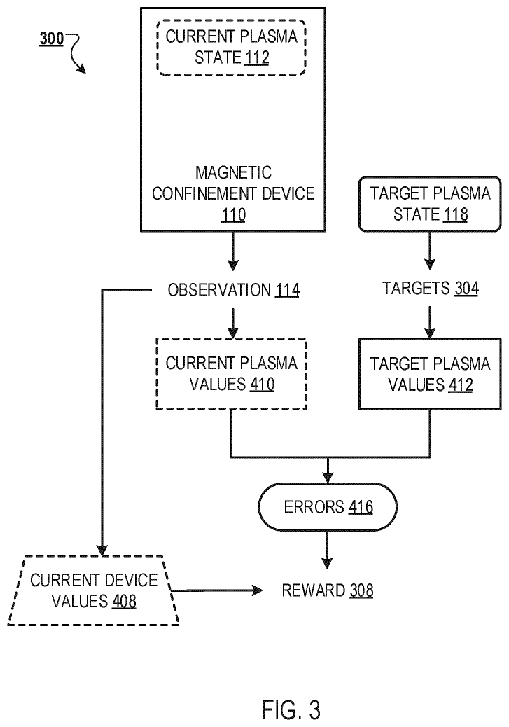

FIG. 2 is a flow diagram of an example process 200 for generating control signals using a plasma confinement neural network that has a plurality of network parameters. The control signals control a magnetic field to confine a plasma within a chamber of a magnetic confinement device. Reference will also be made to FIG. 3, which illustrates an example process 300 for determining a reward that can be used to train the network parameters of the plasma confinement neural network. For convenience, processes 200 and 300 will be described as being performed by a system of one or more computers located in one or more locations. For example, a magnetic field control system, e.g., the magnetic field control system 100 of FIG. 1, appropriately programmed in accordance with this specification, can perform processes 200 and 300.

Referring to FIG. 2, the system obtains an observation characterizing a current state of the plasma in the chamber of the magnetic confinement device (202). In general, the observation includes a set of measurements acquired from various sensors and instruments of the magnetic confinement device. Sophisticated confinement devices can be equipped with a plethora of sensors, many of which may be strongly correlated with one another, e.g., magnetic field sensors, current sensors, optical sensors and cameras, stress/strain sensors, bolometers, temperature sensors, etc. The available measurements can be used by the system to directly and/or indirectly characterize the current plasma state. Note that the system may not be able to acquire all measurements in real-time due to limitations of certain sensors and/or instruments. Nevertheless, these measurements can be used post-process (e.g., after a final time step) in conjunction with real-time measurements at a particular time step to evaluate performance. As some particular examples, an observation may include a measurement of a magnetic field or flux within the magnetic confinement device, or a current measurement from a control coil (i.e. of a current in the control coil).

The system determines a reward for the time step based on at least the current state of the plasma (204). The reward can be minimally specified to give the system maximum flexibility to attain a desired outcome. The reward can also penalize the system if it reaches an undesired terminal condition outside operational limits of the confinement device, e.g., maximum control coil current/voltage, edge safety factor, etc.

Referring to FIG. 3, the reward 308 can indicate whether the plasma features of the current plasma state 112 are equivalent to the plasma features of a target state of the plasma 118. For example, the plasma features can include a plasma stability, a plasma current, a plasma elongation, etc. Plasma stability may refer to positional stability, e.g., stability in vertical position; it may be measured by a rate of change of position with time. Plasma current refers to a current in the plasma. Plasma elongation, e.g. in a tokamak, may be defined as the plasma height divided by its width. Other plasma features include: a shape of the plasma, e.g., a shape of a vertical cross-section through the plasma; a position of the plasma, e.g., a vertical or radial position of an axis or center of the plasma; an area, e.g., a cross-sectional area, of the plasma; a number of domains or droplets of the plasma; a measure of a distance between droplets of plasma (where multiple droplets are present); a radius of (a cross-section of) the plasma, which may be defined as half a width, e.g., a radial width, of a cross-section of the plasma; a triangularity of the plasma, which may be defined as the radial position of the highest point relative to the median radial position (upper triangularity) or as the radial position of the lowest point relative to the median radial position (lower triangularity) or as a mean of the upper triangularity and lower triangularity; and a limit point of the plasma, more specifically a distance between an actual limit point such as a wall of the confinement device or an x-point and target limit point.

The reward 308 can generally be represented as a numerical value that characterizes respective errors 416 between the current plasma state 112 and the target plasma state 118. In some implementations, the respective errors 416 measure a difference between one or more current values 410 of a plasma feature and one or more target values 412 of a plasma feature. The error between the current values 410 and target values 412 of each respective plasma feature can be characterized by any appropriate error metric, e.g., mean squared error, absolute difference, etc. In addition, the reward 308 can be a weighted linear combination of the respective errors 416 corresponding to the plasma features. Appropriately weighting the errors 416 in the reward 308 allows the system to emphasize certain plasma features over others, e.g., plasma current, plasma position, etc.

The current values 410 of the current plasma state 112 can be determined from the set of measurements included in the observation 114. Due to strong coupling between the plasma and the magnetic field in the chamber, real-time magnetic field measurements can be particularly effective at characterizing the current plasma state 112. For example, wire loops can measure a magnetic flux in the confinement device, magnetic field probes can measure the local magnetic field in the device and a current can be measured in active control coils. Note, however, that certain features of the current plasma state 112 may not be directly observable for a particular confinement device (e.g., plasma shape and position). These features may be inferred from the available measurements, for example, by reconstructing the features from related quantities. In some implementations, the system uses a magnetic-equilibrium reconstruction (e.g., LIUQE code), which solves an inverse problem to find a plasma-current distribution respecting a force balance (e.g., a Grad-Shafranov equation) that best matches magnetic field measurements at a specific time step (e.g., in a least-squares sense).

On the other hand, the target values 412 of the target plasma state 118 can be directly specified from time-varying and/or static feature targets 304. The targets 304 can be specified within physically realizable limits to ensure the system is not driven towards an unreachable condition.

The target values 412 associated with the target plasma state 118 can also be included as input data to the plasma confinement neural network. As mentioned previously, the target values 412 can act as a set point for the system at each time step. Hence, the system can control the evolution of the plasma by varying the target values 412 at each time step, such that the current plasma state 112 is driven towards a plasma state with those specific values. The target values 412 at each time step can correspond to a pre-specified routine or they can be specified on-the-fly, allowing a user to manually control evolution of the plasma when the system is deployed.

The reward 308 can also be based, at least in part, on a current value 408 of one or more device features characterizing a current state of the magnetic confinement device 110. For example, the device features can include a number of x-points in the chamber, a respective current in one or more control coils, etc. Generally, the current device values 408 can be obtained from measurements included in the observation 114.

The components of the reward 308 corresponding to current device feature values 408 can be determined from a highly nonlinear process. For instance, the part of the reward 308 based on the current device feature values 408 might be zero, e.g., until the current in a control coil exceeds a limit at which point it may be a large negative value, etc. Hence, the reward 308 can penalize the system if the confinement device leaves a desired operational range.

Returning to FIG. 2, the system processes the observation (and possibly the target values associated with the target plasma state) using the plasma confinement neural network in accordance with the network parameters to generate a magnetic control output (206). The magnetic control output characterizes control signals for controlling the magnetic field of the magnetic confinement device.

The system then generates the control signals for controlling the magnetic field based on the magnetic control output (208).

Note that steps (206) and (208) are not necessarily independent processes as the plasma confinement neural network can also directly output control signals as the magnetic control output.

Although other methods are conceivable, most state-of-the-art magnetic confinement devices pass electric current through a set of control coils to manipulate the magnetic field. In this case, the system can actuate the control coils by applying voltages, which alters the amount of current and therefore the resulting magnetic field. The voltages can be provided by suitable power supplies.

For example, the magnetic control output can specify a respective voltage to be applied to each of the control coils. The system can then generate appropriate control signals that apply the respective voltages to the control coils.

In some implementations, the magnetic control output characterizes a respective score distribution over a set of possible voltages that can be applied to each of the control coils. In this case, the magnetic control output can specify a voltage mean and standard deviation for each score distribution, modelled as Gaussian distributions. The system can then sample voltages from the respective score distributions and generate appropriate control signals that apply the sampled voltages to their respective control coils.

In further implementations, the system generates control signals that apply the voltage means of the score distributions to their respective control coils, i.e., in a deterministic fashion. The stochastic procedure, using voltages sampled from the score distributions, may only be desirable for training purposes so the system can explore successful control options. This procedure is particularly apt for execution on a simulated magnetic confinement device (depicted in FIG. 4), where there is no risk of damaging the confinement device if the system explores poor options. The deterministic procedure, using the voltage means of the score distributions, is predictable and therefore may be better suited for deployment on a real-world magnetic confinement device. Moreover, during training, the deterministic procedure can be monitored in parallel to ensure optimal performance when the system is eventually deployed on a real-world confinement device.

Although the above example describes a voltage actuation approach, the magnetic control output could also specify respective currents for the control coils. The system could then track the currents as a current controller.

Note that the precise number, arrangement and range of control coils depends on the particular design of the confinement device. For tokamaks, these can include poloidal and toroidal coils that control poloidal and toroidal magnetic fields, ohmic transformer coils that can heat and modulate the plasma, fast coils that generate high-frequency fields, as well as various other coils that can be used for many different purposes. Nevertheless, due to the versatility of the plasma confinement neural network, the system can autonomously learn a near-optical control policy for any confinement device as control objectives can be specified at a high level, i.e., with respect to targets of the target plasma state.

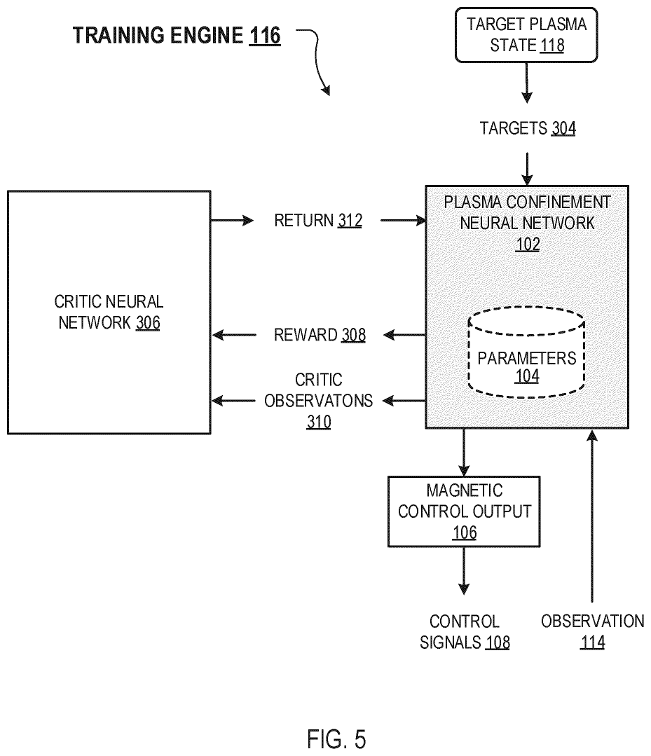

The system trains the network parameters of the plasma confinement neural network on the rewards using a reinforcement learning technique (210). The system can utilize any appropriate reinforcement learning technique to train the network parameters. In general, the system updates the network parameters to optimize the control policy with respect to the rewards characterizing the trajectory of the plasma and magnetic confinement device. In some implementations, the plasma confinement neural network is jointly trained along with a critic neural network using an actor-critic reinforcement learning technique based on the rewards (depicted in FIG. 5). In particular, the system can determine gradients (with respect to the parameters of the plasma confinement neural network and the critic neural network) of a reinforcement learning objective function that depends on the rewards, e.g., using backpropagation. The system can then use the gradients to adjust the current parameter values of the plasma confinement neural network and the critic neural network, e.g., using the update rule of an appropriate gradient descent optimization technique, e.g., RMSprop or Adam.

As mentioned previously, the system can train the network parameters of the neural network on simulated trajectories of a magnetic confinement device. Afterwards, the system can generate control signals for a real-world magnetic confinement device, e.g., a tokamak.

FIG. 4 shows an example simulator 500 that can simulate trajectories of a magnetic confinement device 110 for use in training a magnetic control system, e.g., the magnetic control system 100 of FIG. 1. The simulator 500 is an example of a system implemented as computer programs on one or more computers in one or more locations in which the systems, components, and techniques described below are implemented.

The simulator 500 has enough physical fidelity to describe the evolution of the current plasma state 112 at each time step, while remaining computationally feasible for training. This enables zero-shot transfer to real-world hardware. Note that the simulator 500 can evolve the plasma on shorter timescales than the control rate for the confinement device 110, as the control rate corresponds to the latency in generating control signals 108 in response to an observation 114. The simulator 500 timescale is typically specified on the basis of numerical considerations such as convergence, accuracy, numerical stability, etc.

In some implementations, the simulator 500 models the effects of control coil voltages on the plasma using a free-boundary plasma-evolution model, e.g., using the FGE software package. As mentioned previously, the control coil voltages can be regulated by the control signals 108, which facilitates the interaction of the magnetic control system 100 with the simulator 500. In the free-boundary model, currents in the control coils and passive conductors evolve under the influence of externally applied voltages from power supplies, as well as induced voltages from time-varying currents in other conductors and in the plasma itself. Conductors can be described by a circuit model in which resistivities are known constants and mutual inductances can be computed analytically.

Assuming axisymmetric plasma configurations, the simulator 500 can model the plasma with the Grad-Shafranov equation, resulting from the balance between the Lorentz force \vec{j}×\vec{B}, i.e., the interaction between the plasma current density \vec{j} and the magnetic field \vec{B}, and the pressure gradient Δₚ within the plasma. Evolution of total plasma current Iₚ can be modelled by the simulator 500 using a lumped-parameter equation based on the generalized Ohm's law for magnetohydrodynamics. For this model, the total plasma resistance Rₚ and total plasma self-inductance Lₚ are free parameters.

In some implementations, the simulator 500 does not model the transport of radial pressure and current density from heat and current drive sources, although a more sophisticated framework could include these effects. Instead, the simulator 500 can model the plasma radial profiles as polynomials whose coefficients are constrained by the plasma current Iₚ and two free parameters: (i) the normalized plasma pressure βₚ, i.e., the ratio of kinetic pressure and magnetic pressure, and (ii) the safety factor at the plasma axis q_{A} which controls the current density peakedness.

The plasma-evolution parameters Rₚ, Lₚ, βₚ and q_{A} can vary across an appropriate range to account for uncontrollable experimental conditions in real-world magnetic confinement devices 110, where the variation can be identified from experimental data. Other parameters can also vary if desired. For example, at the beginning of each training simulation, the simulator 500 can independently sample the parameters from respective log-uniform distributions. This provides robustness to the control system 100 while ensuring performance since the system 100 is forced to learn a control policy that handles all combinations of these parameters.

The simulator 500 can produce a synthetic observation 114 in the form of simulated sensor measurements that mimic measurements from a real-world magnetic confinement device 110. The control system 100 can then process the observation 114 to complete a control loop for the time step. For example, the simulator 500 can produce synthetic magnetic field measurements from respective wire loops, magnetic field probes and control coils included in the simulation. Provided sufficient data characterizing a particular real-world confinement device 110, the simulator 500 can also describe sensor delay and noise, e.g., using a time delay and a Gaussian noise model, as well as control-voltage offsets due to the power supply dynamics, e.g., using a fixed bias and a fixed time delay.

Although the simulator 500 is generally accurate, there are regions where the dynamics of the current plasma state 112 may be poorly represented or the simulation is outside operational limits of the confinement device 110. The control system 100 can avoid these regions of the simulator 500 by using appropriate rewards and termination conditions. For example, at each time step, the simulator 500 can determine if the current plasma state 112 and confinement device 110 are physically feasible 502, that is, if they satisfy certain constraints. If these physical feasibility constraints are violated, the simulator 500 can terminate the simulation 504 at the time step. The simulator 500 can also penalize the control system 100 with a large negative reward if it reaches a termination condition to teach the system 100 to circumvent these regions.

In some implementations, the feasibility constraints can include determining that a plasma density, a plasma current, or a respective current in each of one or more control coils does not satisfy a particular threshold. For example, such a threshold may indicate a minimum value below which the control system may become “stuck”. Other constraints can be implemented straightforwardly.

FIG. 5 is an example training engine 116 using an actor-critic reinforcement learning technique to jointly train a plasma confinement neural network 102 and a critic neutral network 306.

The training engine 116 can train the plasma confinement neural network 102 to generate control signals 108 that increase a “return” 312. The return 312 can be produced by the critic neural network 306 by processing critic observations 310 of the plasma confinement neural network 102. The critic observations 310 characterize the control signals 108 generated in response to the observation 114 based on the reward 308, as will be described in more detail below. In this case, a return 312 refers to a cumulative measure of rewards, e.g., a discounted expected future measure of rewards such as a time-discounted sum of rewards. An actor-critic reinforcement learning technique can use the output of the critic neural network 306, i.e. the return 312, directly or indirectly to train the plasma confinement neural network 102. Note that the critic neural network 306 is only needed during training.

The computational requirements of the training engine 116 are normally elevated when the simulator 500 is used to model the confinement device 110, as the plasma physics are incredibly intricate. This can slow the data rate substantially compared with a typical reinforcement learning environment, e.g., computer games. To overcome the paucity of data, the training engine 116 can use a maximum a posteriori policy optimization (MPO) technique (Abdolmaleki et al., “Maximum a Posteriori Policy Optimisation”, arXiv: 1806.06920, 2018, or a variant thereof). MPO supports a distributed architecture that can collect data across multiple parallel streams. In general, the distributed architecture allows a global set of network parameters to be defined for the plasma confinement neural network 102 and critic neural network 306, e.g., in central memory. Multiple parallel steams (e.g., independent threads, GPUs, TPUs, CPUs, etc.) can execute a local training engine 116 using the current set of network parameters. Each stream can then update the global network parameters with the results of the local training engine 116. This approach can significantly speed up the training process for the control system 100.

The plasma confinement neural network 102 and the critic neural network 306 can each have any appropriate neural network architectures which enable them to perform their described functions. For example, their respective architectures can each include any appropriate types of neural network layers (e.g., fully-connected layers, convolutional layers, recurrent layers, or attention layers) in any appropriate numbers (e.g., 3 layers, 10 layers, or 100 layers) and connected in any appropriate configuration (e.g., as a linear sequence of layers). As an example the plasma confinement neural network 102 can be a feedforward neural network such as a multilayer perceptron (MLP), and the critic neural network 306 can be a recurrent neural network e.g., including an LSTM (Long Short Term Memory) layer.

However, to be suitable as a real-time-controller, the neural networks 102/306 can exploit the inherent asymmetry in the actor-critic architecture to ensure the trained plasma confinement neural network 102 executes quickly and efficiently once deployed. This asymmetric property is particularly beneficial due to the fact that the critic neural network 306 is only needed during training, allowing the critic 306 to infer underlying states from measurements, deal with complex state-transition dynamics over different timescales and assess the influence of system measurement and action delays.

For example, to guarantee low latency outputs, the plasma confinement neural network 102 can be a feedforward neural network with a limited number of layers, e.g., four layers. On the other hand, the critic neural network 306 can be a much larger recurrent neural network since higher latency outputs for the critic 306 are acceptable during training. Consequently, the critic neural network 306 can have considerably more network parameters than the plasma confinement neural network 102. Moreover, the critic neural network 308 can process critic observations 310 with higher dimensionality and more data than observations 114 processed by the plasma confinement neural network 102. Consequently, the critic neural network 306 can be configured to consume more computational resources than the plasma confinement neural network 106.

The critic observations 310 can include all data involved in the control loop of the magnetic field control system 100 for the time step, i.e., the observation 114, targets 304, and control signals 108. The critic 306 can process the critic observations 310 along with the reward 308 determined for the time step to generate the return 312. The return 312 predicts the cumulative future rewards for the control system 100 at the particular time step.

After completing a trajectory, the training engine 116 can compare the return 312 at each time step with the actual cumulative future rewards. The training engine 116 can train the critic neural network 306, i.e., by updating network parameters, to generate returns 312 that accurately predict the cumulate future rewards. Conversely, the training engine 116 can train the plasma confinement neural network 102 to generate control signals 108 which maximize the return 312 generated from the critic 306. Examples of actor-critic reinforcement learning techniques are described in more detail with reference to Volodymyr Minh et al., “Asynchronous methods for deep reinforcement learning,” arXiv: 1602.01783v2, 2016.

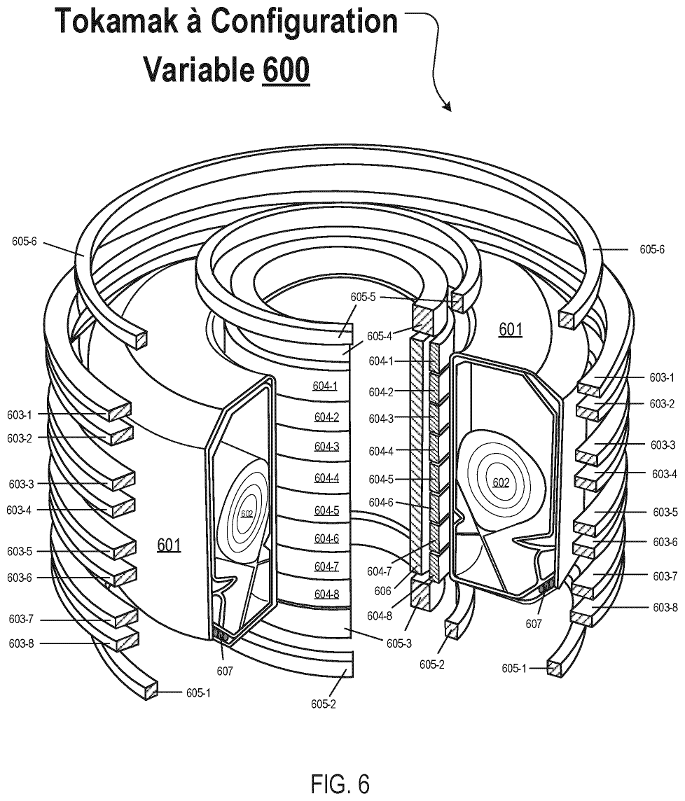

FIG. 6 is a rendered image of Tokamak a Configuration Variable (TCV) 600. TCV 600 is a research tokamak at the Swiss Plasma Center, with a major radius of 0.88 m, a chamber height of 1.50 m and a chamber width of 0.512 m. TCV 600 has a versatile collection of control coils enabling a wide array of plasma configurations. A chamber 601 is surrounded by sixteen poloidal field coils (eight inner poloidal coils 603-1 . . . 8 and eight outer poloidal coils 604-1 . . . 8), seven ohmic transformer coils (six ohmic coils in series 605-1 . . . 6 and a central ohmic coil 606) and a fast G coil 607. Note that not all control coils of TCV 600 are depicted in FIG. 6.

TCV 600 was utilized to conduct an experimental demonstration of the magnetic field control system 100 to confine a plasma 602 within the chamber 601 of the device. A thorough review of the experiment, as well as experiments involving different plasma configurations, is provided by Degrave, J., Felici, F., Buchli, J. et al. “Magnetic control of tokamak plasmas through deep reinforcement learning”, Nature 602, 414-419 (2022).

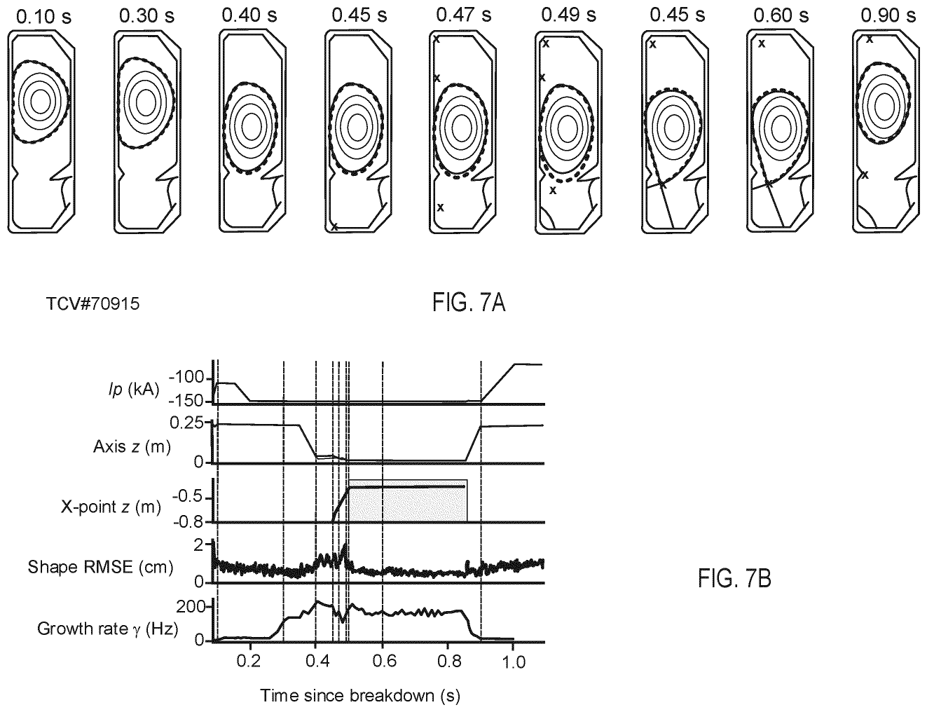

FIGS. 7A and 7B are experimental data of TCV #70915 showing control of multiple plasma features using the magnetic field control system 100.

FIG. 7A shows target shape points with 2 cm radius (dots), compared with the post-experiment equilibrium reconstruction (continuous lines). FIG. 7B shows target time traces compared with reconstructed observations, with the window of diverted plasma marked (shaded rectangle). In the initial limited phase (0.1 s to 0.45 s), the Iₚ root-mean-square error (RMSE) is 0.71 kA (0.59% of the target) and the shape RMSE is 0.78 cm (3% of the vessel half width). In the diverted phase (0.55 s to 0.8 s), the Iₚ and shape RMSE are 0.28 kA and 0.53 cm, respectively (0.2% and 2.1%), yielding RMSE across the full window (0.1 s to 1.0 s) of 0.62 kA and 0.75 cm (0.47% and 2.9%).

The control system 100 used thirty-four of wire loops that measure magnetic flux, thirty-eight probes that measure the local magnetic field and nineteen measurements of the current in active control coils (augmented with an explicit measure of the difference in current between the ohmic coils). The nineteen active control coils, that included the sixteen poloidal coils 603-1 . . . 8 and 604-1 . . . 8 and three ohmic coils 605-2, 605-3 and 606, were actuated to manipulate the plasma 602. The control system 100 consumes the magnetic and current sensors of TCV 600 at a 10 kHz control rate. The control policy produces a reference voltage command at each time step for the active control coils.

Examples of reward components that were used in learning to control TCV 600 are given in Table 1 below. The TCV configuration (characteristic plasma shape), depends on the combination of rewards used. One or more of these reward components may similarly be combined to determine a reward for training the plasma confinement neural network to control the magnetic field for other magnetic confinement devices, e.g., other tokamaks.

TABLE 1

| Reward Component | Description |
|---|---|
| Diverted | Whether the plasma is limited by the wall or diverted through an X-point. |
| E/F Currents | The currents in the E and F coils, in amperes. |
| Elongation | The elongation of the plasma, this is its height divided by its width. |
| LCFS Distance | The distance in meters from the target points to the nearest point on the |
| | last closed flux surface (LCFS). |
| Legs Normalized Flux | The difference in normalized flux from the flux at the LCFS at target leg |
| | points. |
| Limit Point | The distance in meters from the actual limit point (wall or X-point) and |
| | target limit point. |
| OH Current Diff | The difference in amperes between the two OH coils. |
| Plasma Current | The plasma current in amperes. |
| R | The radial position of the plasma axis/centre. |
| Radius | Half of the width of the plasma, in meters. |
| Triangularity | The upper triangularity is defined as the radial position of the highest point |
| | relative to the median radial position. The overall triangularity is the mean |
| | of the upper and lower triangularity. |
| Voltage Out of Bounds | Penalty for going outside of the voltage limits. |
| X-point Count | Return the number of actual and requested X-points within the vessel. |
| X-point Distance | Returns the distance in meters from actual X-points to target X-points. Only |
| | X-points within 20 cm are considered. |
| X-point Far | For any X-point that isn't requested, return the distance in meters from the |
| | X-point to the LCFS. This helps avoid extra X-points that may attract the |
| | plasma and lead to instabilities. |
| X-point Flux Gradient | The gradient of the flux at the target location with a target of 0 gradient. This |
| | encourages an X-point to form at the target location, but isn't very precise |
| | on the exact location. |
| X-point Normalized Flux | The difference in normalized flux from the flux at the LCFS at target X- |
| | points. This encourages the X-point to be on the last closed flux surface, and |
| | therefore for the plasma to be diverted. |
| Z | The vertical position of the plasma axis/centre, in meters. |

An example combination of rewards used to obtain the plasma shapes of FIG. 7A combines: LCFS Distance (good=0.005, bad=0.05), Limit Point (good=0.1, bad=0.2), OH Current Diff (good=50, bad=1050), Plasma Current (good=500, bad=20000), X-point Distance (good=0.01, bad=0.15), X-point Far (good=0.3, bad=0.1), X-point Flux Gradient (good=0, bad=3), X-point Normalized Flux (good=0, bad=0.08); where each of these components is mapped to a range between “good” and “bad” values, e.g., using a sigmoid function (with a weight of 1 in the combination except for X-point Flux Gradient which has a weight of 0.5). Other combinations of rewards can be used to obtain other shapes (and multiple droplets at different positions can be obtained e.g. by defining multiple targets for R and Z).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus for generating control signals for controlling a magnetic field for confining plasma in a chamber of a magnetic confinement device, the method comprising, at each of a plurality of time steps:
obtaining an observation characterizing a current state of the plasma in the chamber of the magnetic confinement device;
processing an input comprising the observation characterizing the current state of the plasma in the chamber of the magnetic confinement device using a plasma confinement neural network, wherein the plasma confinement neural network has a plurality of network parameters and is configured to process the input comprising the observation in accordance with the network parameters to generate a magnetic control output that characterizes control signals for controlling the magnetic field of the magnetic confinement device; and
generating the control signals for controlling the magnetic field of the magnetic confinement device based on the magnetic control output.

2. The method of claim 1, wherein the magnetic control output characterizes a respective voltage to be applied to each of a plurality of control coils of the magnetic confinement device.

3. The method of claim 2, wherein the magnetic control output defines, for each of the plurality of control coils of the magnetic confinement device, a respective score distribution over a set of possible voltages that can be applied to the control coil.

4. The method of claim 3, wherein generating control signals for controlling the magnetic field of the magnetic confinement device based on the magnetic control output comprises, for each of the plurality of control coils of the magnetic confinement device:
selecting a voltage from the respective score distribution over the set of possible voltages that can be applied to the control coil; and
generating a control signal to cause the sampled voltage to be applied to the control coil.

5. The method of claim 1, further comprising:
determining, for each of the plurality of time steps, a reward for the time step that characterizes an error between: (i) the current state of the plasma, and (ii) a target state of the plasma; and
training the neural network parameters of the plasma confinement neural network on the rewards using a reinforcement learning technique.

6. The method of claim 5, wherein for one or more of the plurality of time steps, determining the reward for the time step comprises:
determining, for each of one or more plasma features characterizing the plasma, a respective error that measures a difference between: (i) a current value of the plasma feature at the time step, and (ii) a target value of the plasma feature at the time step; and
determining the reward for the time step based at least in part on the respective error corresponding to each of the one or more plasma features at the time step.

7. The method of claim 6, wherein for one or more of the plurality of time steps, determining the reward for the time step based on the respective error corresponding to each of the plasma features at the time step comprises:
determining the reward for the time step as a weighted linear combination of the respective errors corresponding to the plasma features at the time step.

8. The method of claim 6, wherein the respective target values of each of one or more of the plasma features vary between time steps.

9. The method of claim 6, wherein at each of the plurality of time steps, the input to the plasma confinement neural network includes data defining the respective target value of each of the plasma features at the time step in addition to the observation for the time step.

10. The method of claim 6, wherein the plasma features comprise one or more of: a stability of the plasma, a plasma current of the plasma, a shape of the plasma, a position of the plasma, an area of the plasma, a number of domains of the plasma, a distance between droplets of plasma, an elongation of the plasma, a radial position of a plasma center, a radius of the plasma, a triangularity of the plasma, or a limit point of the plasma.

11. The method of claim 5, wherein for one or more of the plurality of time steps, determining the reward for the time step comprises:
determining a respective current value of each of one or more device features characterizing a current state of the magnetic confinement device; and
determining the reward for the time step based at least in part on the respective current values of the one or more device features at the time step.

12. The method of claim 11, wherein the device features comprise: a number of x-points in the chamber of the magnetic confinement device, a respective current in each of one or more control coils of the magnetic confinement device, or both.

13. The method of claim 1, wherein the magnetic confinement device is a simulation of a magnetic confinement device, and further comprising, at a final time step of the plurality of time steps:
determining that a physical feasibility constraint of the magnetic confinement device is violated at the time step; and
terminating the simulation of the magnetic confinement device in response to determining that the physical feasibility constraint of the magnetic confinement device is violated at the time step.

14. The method of claim 13, wherein determining that the physical feasibility constraint of the magnetic confinement device is violated at the time step comprises one or more of: determining that a density of the plasma at the time step does not satisfy a threshold, determining that a plasma current of the plasma at the time step does not satisfy a threshold, or determining that a respective current in each of one or more of the control coils does not satisfy a threshold.

15. The method of claim 5, wherein the reinforcement learning technique is an actor-critic reinforcement learning technique, and wherein training the network parameters of the plasma confinement neural network on the rewards comprises:
jointly training the plasma confinement neural network and a critic neural network on the rewards using the actor-critic reinforcement learning technique, wherein the critic neural network is configured to process an input comprising a critic observation for a time step to generate an output that characterizes a cumulative measure of rewards that are predicted to be received after the time step.

16. The method of claim 15, wherein the actor-critic reinforcement learning technique is a maximum a posteriori policy optimization (MPO) technique.

17. The method of claim 15, wherein the actor-critic reinforcement learning technique is a distributed actor-critic reinforcement learning technique.

18. The method of claim 15, wherein the plasma confinement neural network generates outputs using fewer computational resources than are required by the critic neural network to generate outputs.

19.-28. (canceled)

29. A system comprising:
one or more computers; and
one or more storage devices communicatively coupled to the one or more computers, wherein the one or more storage devices store instructions that, when executed by the one or more computers, cause the one or more computers to perform operations for generating control signals for controlling a magnetic field for confining plasma in a chamber of a magnetic confinement device, the operations comprising, at each of a plurality of time steps:
obtaining an observation characterizing a current state of the plasma in the chamber of the magnetic confinement device;
processing an input comprising the observation characterizing the current state of the plasma in the chamber of the magnetic confinement device using a plasma confinement neural network, wherein the plasma confinement neural network has a plurality of network parameters and is configured to process the input comprising the observation in accordance with the network parameters to generate a magnetic control output that characterizes control signals for controlling the magnetic field of the magnetic confinement device; and
generating the control signals for controlling the magnetic field of the magnetic confinement device based on the magnetic control output.

30. (canceled)

31. One or more non-transitory computer storage media storing instructions that when executed by one or more computers cause the one or more computers to perform operations for generating control signals for controlling a magnetic field for confining plasma in a chamber of a magnetic confinement device, the operations comprising, at each of a plurality of time steps:
obtaining an observation characterizing a current state of the plasma in the chamber of the magnetic confinement device;
processing an input comprising the observation characterizing the current state of the plasma in the chamber of the magnetic confinement device using a plasma confinement neural network, wherein the plasma confinement neural network has a plurality of network parameters and is configured to process the input comprising the observation in accordance with the network parameters to generate a magnetic control output that characterizes control signals for controlling the magnetic field of the magnetic confinement device; and
generating the control signals for controlling the magnetic field of the magnetic confinement device based on the magnetic control output.
